(19) United States
(12) Patent Application Publication
(10) Pub. No.: US 2025/0076505 A1
(43) Pub. Date: Mar. 6, 2025

(54) Method for Calibrating a First Lighting Device, a Second Lighting Device and an Optical Sensor, Control Device for Carrying Out Such a Method, Calibrating Device Having Such a Control Device, and Motor Vehicle Having Such a Calibrating Device

(71) Applicant: Daimler Truck AG, Leinfelden-Echterdingen (DE)

(72) Inventor: Fridtjof STEIN, Ostfildern (DE)

(21) Appl. No.: 18/253,557

(22) PCT Filed: Oct. 7, 2021
(86) PCT No.: PCT/EP2021/077683

§ 371 Date: May 18, 2023

(30) Foreign Application Priority Data
Nov. 19, 2020 (DE) 10 2020 007 064.7

(51) Int. Cl. G01S 17/89; G01C 11/06; G01M 11/06; G01S 7/497; G06V 10/141; G06V 20/56

(52) U.S. Cl. CPC G01S 17/89; G01C 11/06; G01M 11/064; G01M 11/068; G01S 7/497; G06V 10/141; G06V 20/56; G01S 2007/4977

(57) ABSTRACT

A method for calibrating a first lighting device, a second lighting device, and an optical sensor includes controlling the first lighting device, the second lighting device, and the optical sensor in a temporally coordinated manner and associating the controlling with a visible distance range. The method further includes capturing a first recorded image with the optical sensor by the controlling during an illumination by the first lighting device, capturing a second recorded image with the optical sensor by the controlling during an illumination by the second lighting device, and forming a differential recorded image as a difference between the first recorded image and the second recorded image. The coordinated controlling and/or the first lighting device and/or the second lighting device is evaluated and/or changed on a basis of the differential recorded image.

### BACKGROUND AND SUMMARY OF THE INVENTION

The invention relates to a method for calibrating a first lighting device, a second lighting device and an optical sensor, a control device for carrying out such a method, a calibrating device having such a control device, and a motor vehicle having such a calibrating device.

A method for calibrating a lighting device results from the European patent application with the publication number EP 3 308 193 B1. In this method, light pulses are emitted by means of the lighting device. These emitted light pulses are compared with a reference light pulse, and based on this comparison, the lighting device is calibrated.

The documents U.S. Pat. No. 5,034,810 B1 and DE 102 50 705 A1 furthermore show a method in which, by means of light pulses emitted by a lighting device, and a gated camera, at least two images are captured and, by means of a control device, a differential recorded image is created from these two images. However, in this method, the interaction of lighting device and optical sensor is not considered.

A temporal coordination of the controlling of an optical sensor and a lighting device is furthermore known from the documents US 20180113200 A1 and DE 102020003199 A1.

Furthermore, a method for calibrating a lighting device and an optical sensor is disclosed in the document DE 10 2020 004 989 A1.

However, this method lacks the reference to a second lighting device.

A method for object recognition in recorded images uses the shadow of objects to be recognized, which occurs as a result of at least two lighting devices that are physically spaced apart from each other. In order to be able to carry out a reliable and robust extraction of the respective shadows, the at least two lighting devices and the optical sensor must be exactly calibrated.

A basic principle when calibrating a technical system is that the dimensions of the environment in which the calibrating is undertaken and the dimensions of the environment in which the technical system is operated are as identical as possible. For object recognition at distances of up to 200 m, this can only be realized in a cost-and space-saving manner with great difficulty.

The object of the invention is therefore to provide method for calibrating a first lighting device, a second lighting device and an optical sensor, a control device for carrying out such a method, a calibrating device having such a control device, and a motor vehicle having such a calibrating device, wherein the mentioned disadvantages are at least partially resolved, preferably avoided.

The object is in particular solved in that a method for calibrating a first lighting device, a second lighting device and an optical sensor is provided, wherein the first lighting device, the second lighting device and the optical sensor are controlled in a temporally coordinated manner and the coordinated controlling is associated with a visible distance range. By means of the coordinated controlling, a first recorded image is captured with the optical sensor during an illumination by means of the first lighting device. By means of the coordinated controlling, a second recorded image is captured with the optical sensor during an illumination by means of the second lighting device. Furthermore, a differential recorded image is formed as the difference between the first recorded image and the second recorded image, wherein the coordinated controlling and/or the first lighting device and/or the second lighting device are evaluated and/or changed on the basis of the differential recorded image.

With the help of the method it is advantageously possible, based on a few recorded images, preferably two recorded images, to calibrate the controlling of the first lighting device, the second lighting device and the optical sensor. The calibrating in particular comprises the orchestration of the first lighting device, the second lighting device and the optical sensor.

Furthermore, it is advantageously possible with the method to recognize and to compensate for ageing effects in the components of the first lighting device, the second lighting device and the optical sensor. Preferably, a possible future failure of a component due to ageing effects is also recognized early, whereupon an exchange of the respective component can be initiated.

Calibrating the first lighting device, the second lighting device and the optical sensor also advantageously occurs during the journey of a motor vehicle that has the first lighting device, the second lighting device and the optical sensor, in particular preferably during a journey in real conditions, on a real road, especially preferably a public street, like, for example, a country road or a motorway. The dimensions of the environment in which the calibrating is carried out and the dimensions of the environment in which the first lighting device, the second lighting device and the optical sensor are operated are thus identical.

Calibrating the first lighting device, the second lighting device and the optical sensor ensures that ageing effects and/or dirtying of the first lighting device and/or the second lighting device and/or the optical sensor do not distort the distance measuring.

The method for generating recorded images by means of controlling at least one lighting device and an optical sensor in a temporally coordinated manner is in particular a method known as a gated imaging method; the optical sensor is in particular a camera, which is only switched to be sensitive in a certain, limited time range, which is referred to as “gated control”, the camera is thus a gated camera. The at least one lighting device is also correspondingly only temporally controlled in a certain, selected time interval in order to illuminate an object-side scene.

In particular, a predefined number of light pulses are emitted by the first lighting device and the second lighting device, preferably each with a duration between 5 s and 20 ns. The start and the end of the exposure of the optical sensor is coupled with the number and duration of the emitted light pulses. As a result of this, a certain visible distance range can be recorded by the optical sensor by means of the temporal controlling on the one hand of the first lighting device, the second lighting device and on the other hand of the optical sensor with a correspondingly defined spatial location, i.e., in particular certain distances of a near and a distant boundary of the visible distance range from the optical sensor.

The visible distance range is thereby that-object-side-range in three-dimensional space that is shown in a two-dimensional recorded image on an image plane of the optical sensor by means of the number and duration of the light pulses of the first lighting device and/or of the second lighting device in connection with the start and the end of the exposure of the optical sensor.

If “object-side” is referred to here and in the following, a region in real space is being discussed. If “image-side” is referred to here and in the following, a region on the image plane of the optical sensor is being discussed. The visible distance range is thereby given on the object side. This corresponds to an image-side region on the image plane assigned by the laws of imaging as well as the temporal controlling of the first lighting device, the second lighting device and the optical sensor.

Depending on the start and the end of the exposure of the optical sensor after the beginning of the illumination by the first lighting device and/or the second lighting device, light pulse photons hit the optical sensor. The further the visible distance range is spaced apart from the first lighting device and/or the second lighting device and the optical sensor, the longer the temporal duration until a photon, which is reflected in this distance range, hits the optical sensor. The time interval between an end of the lighting and a beginning of the lighting therefore gets longer, the further the visible distance range is spaced apart from the first lighting device, the second lighting device and from the optical sensor.

According to an embodiment of the method it is therefore in particular possible to define the location and the physical width of the visible distance range, in particular a distance between the near boundary and the distant boundary of the visible distance range, by means of a correspondingly suited choice of the temporal controlling of the first lighting device and/or the second lighting device, on the one hand, and of the optical sensor on the other hand.

In a preferred embodiment of the method, the visible distance range is predefined, wherein the temporal coordination of the first lighting device and/or of the second lighting device, on the one hand, and of the optical sensor, on the other hand is determined and correspondingly predefined.

In a preferred embodiment, the lighting device has at least one surface emitter, in particular a so-called VCSE laser. Alternatively or additionally, the optical sensor is preferably a camera.

Preferably, the coordinated controlling of the first lighting device, the second lighting device and the optical sensor is evaluated and/or changed in such a way that a first image-side visible distance range in the first recorded image and a second image-side visible distance range in the second recorded image represent an identical region of the object-side observation region. Alternatively or additionally, the coordinated controlling of the first lighting device, the second lighting device and the optical sensor is evaluated and/or changed in such a way that the luminous intensity in the first recorded image and the luminous intensity in the second recorded image is identical.

In a preferred embodiment of the method, an image registration is carried out in the first recorded image and the second recorded image before the formation of the differential recorded image. Advantageously, in the differential recorded image, it can be determined in a simple manner whether the first image-side visible distance range in the first recorded image and the second image-side visible distance range in the second recorded image represent the identical region of the object-side observation region and/or have the identical luminous intensity.

In a further preferred embodiment of the method, a first brightness distribution in the first recorded image is compared with a second brightness distribution of the second recorded image. Advantageously, an evaluation and/or change of the coordinated controlling is possible in a simple manner, based on a comparison of the first brightness distribution and the second brightness distribution.

In the context of the present technical teaching, a brightness distribution assigns a luminous intensity to every image line of the optical sensor, and thus to all points of the observation region that are at an identical distance to the optical sensor. Preferably, the luminous intensity of an image line comes from the sum of the luminous intensities of all pixels of the respective image line. Alternatively, the luminous intensity of an image line comes from the average of the luminous intensities of all pixels of the respective image line.

In a further preferred embodiment of the method, the first recorded image and the second recorded image are captured in a time interval of less than 0.01 seconds, preferably less than 0.001 seconds.

According to a development of the invention, it is provided that a plurality of first recorded images and a plurality of second recorded images are alternately captured. Furthermore, an average first recorded image is determined from the plurality of first recorded images and an average second recorded image is determined from the plurality of second recorded images. The differential recorded image is then formed as the difference between the average first recorded image and the average second recorded image. It is thus advantageously guaranteed that brief interference signals are filtered out, in order to detect actually existing differences between the image-side visible distance ranges and the luminous intensities.

In a preferred embodiment of the method, an image registration is carried out for a first recorded image of the plurality of first recorded images and a subsequent first second recorded image of the plurality of second recorded images.

According to a development of the invention, it is provided that a third recorded image is captured with the optical sensor without illumination by means of the first lighting device or the second lighting device. Furthermore, the differential recorded image is formed from the first recorded image, the second recorded image and the third recorded image. The third recorded image in particular corresponds to a daylight recorded image. Advantageously, the influence of the daylight when calibrating the first lighting device, the second lighting device and the optical sensor is eliminated by means of subtracting the third recorded image.

In an embodiment of the method, the third recorded image is captured after the first recorded image, for example the first first recorded image, and after a second recorded image that follows on from the first recorded image, for example the first second recorded image.

In a further embodiment of the method, the third recorded image is captured after the first recorded image, for example the first first recorded image. After the third recorded image, a second recorded image, for example the first second recorded image, is captured.

In a further embodiment of the method, the third recorded image is captured before the first recorded image, for example the first first recorded image, and before a second recorded image, for example the first second recorded image.

In a preferred embodiment of the method, the differential recorded image is formed as an overall difference of a first difference of the first recorded image and the third recorded image and a second difference of the second recorded image and the third recorded image.

According to a development of the invention, it is provided that at least one recorded image, from which the differential recorded image is formed, is calibrated with a lighting factor. The lighting factor is determined based on a difference of the luminous intensities between the first lighting device and the second lighting device. Advantageously, a known difference of the luminous intensities between the first lighting device and the second lighting device is thus compensated for, before the differential recorded image is determined.

In the context of the present technical teaching, the lighting factor is a correction factor, in order to scale the luminous intensities of a recorded image, preferably comprehensively and homogeneously.

In an embodiment of the method, a failure of individual lighting elements of the first lighting device and/or of the second lighting device are compensated for with the lighting factor.

According to a development of the invention, it is provided that at least one recorded image, from which the differential recorded image is formed, is calibrated with a rim light fall-off correction. The rim light fall-off correction is determined based on the rim light fall-off of the optical sensor. Advantageously, a darkening of the recorded image or decrease of the brightness around the image rim is thus corrected. In a preferred embodiment, the rim light fall-off of the optical sensor and thus also the rim light fall-off correction is known.

According to a development of the invention, it is provided that the first lighting device, the second lighting device and the optical sensor are included in the coordinated controlling with the intrinsic speed of a motor vehicle, which has the first lighting device, the second lighting device and the optical sensor. Advantageously, the coordinated controlling is thus evaluated and/or changed on the basis of the current intrinsic speed of the motor vehicle.

A consideration of the current intrinsic speed is advantageous, since the distance from the motor vehicle to a desired visible distance range between the first recorded image and the second recorded image changes according to speed. At an intrinsic speed of 50 km/h and a time interval of 0.01 seconds between the first recorded image and the second recorded image, the distance from the motor vehicle to the desired visible distance range decreases by around 14 cm. A time interval between a start of the illumination by means of the second lighting device and a start of the exposure of the optical sensor must thus be chosen to be around 1 ns shorter than the illumination by means of the first lighting device, in order to capture the identical desired visible distance range. At an intrinsic speed of 100 km/h and a time interval of 0.01 seconds between the first recorded image and the second recorded image, the previous values double to around 28 cm and around 2 ns.

In an embodiment of the method, a calibration of the first lighting device, of the second lighting device and of the optical sensor is carried out based on a first visible distance range and a second visible distance range, which is different from the first visible distance range.

The object is also solved in that a control device is provided that is configured in order to carry out a method according to the invention or a method according to one or more of the previously described embodiments. The control device is preferably formed as a computing device, especially preferably as a computer, or as a control unit, in particular as a control unit of a motor vehicle. In the context of the control device, the advantages in particular result which were already discussed in connection with the method.

The object is also solved in that a calibrating device is provided that has a first lighting device, a second lighting device, an optical sensor and a control device according to the invention, or a control device according to one or more of the previously described exemplary embodiments. The control device is preferably operatively connected with the first lighting device, the second lighting device and the optical sensor and is configured for controlling them. In the context of the calibrating device, the advantages in particular result which were already discussed in connection with the method and the control device.

In a preferred exemplary embodiment, a first distance between the first lighting device and the optical sensor is smaller than a second distance between the second lighting device and the optical sensor. Especially preferably, the first distance is less than 50 cm, preferably less than 20 cm, preferably less than 10 cm. Especially preferably, the second distance is also more than 50 cm, preferably more than 100 cm, preferably more than 150 cm.

According to a development of the invention, it is provided that the calibrating device has a device chosen from a group consisting of a communication device, a first cleaning device for the first lighting device, and a second cleaning device for the second lighting device.

In an exemplary embodiment, the calibrating device has a communication device. Preferably, the communication device is configured in order to transmit the status of the calibration and/or a successful or non-successful calibration of the first lighting device, the second lighting device and the optical sensor to a receiver, preferably a driver of a motor vehicle having the calibrating device. Alternatively or additionally, the communication device is configured in order to transmit information about a calibration of the first lighting device, the second lighting device and the optical sensor to a computer centre and/or to a workshop.

In a further exemplary embodiment, the calibrating device has a first cleaning device for the first lighting device. Alternatively or additionally, the calibrating device has a second cleaning device for the second lighting device. By means of such a cleaning device it is advantageously possible to clean the lighting device attached to the cleaning device, in particular to eliminate dirt deposits, and thus to enable an optimal lighting.

In a preferred exemplary embodiment, the calibrating device has a communication device, a first cleaning device for the first lighting device and a second cleaning device for the second lighting device.

The object is then also solved in that a motor vehicle with a calibrating device according to the invention or a calibrating device according to one or more of the previously described exemplary embodiments is provided. In the context of the motor vehicle, the advantages in particular result which were already discussed in connection with the method, the control device and the calibrating device.

In an advantageous embodiment, the motor vehicle is formed as a lorry. It is, however, also possible that the motor vehicle is a passenger car, a commercial vehicle or another motor vehicle.

In a preferred exemplary embodiment, the motor vehicle is a lorry. The optical sensor and the first lighting device are arranged above the windscreen and are at a distance of less than 50 cm from each other-the first distance-preferably less than 20 cm, preferably less than 10 cm. The second lighting device is preferably arranged in the region of the bumper.

The invention is illustrated in greater detail below by means of the drawings.

### BRIEF DESCRIPTION OF THE DRAWINGS

FIG. 1 shows a schematic representation of an exemplary embodiment of a motor

vehicle with an exemplary embodiment of a calibrating device;

FIGS. 2a and 2b show a schematic representation of a first differential recorded image and a first example of a first brightness distribution and a second brightness distribution;

FIGS. 3a and 3b show a schematic representation of a second differential recorded image and a second example of a first brightness distribution and a second brightness distribution; and

FIG. 4 shows a schematic representation of a third example of a first brightness distribution and a second brightness distribution.

### DETAILED DESCRIPTION OF THE DRAWINGS

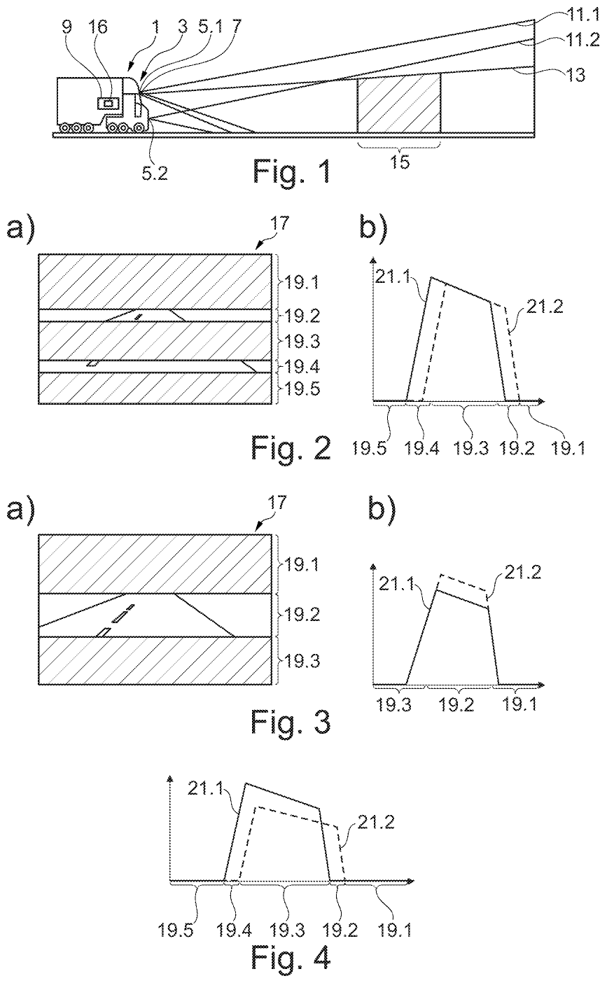

FIG. 1 shows a schematic representation of an exemplary embodiment of a motor vehicle 1 with an exemplary embodiment of a calibrating device 3. The calibrating device 3 has a first lighting device 5.1, a second lighting device 5.2, an optical sensor 7, in particular a camera, and a control device 9. The control device 9 is operatively connected with the first lighting device 5.1, the second lighting device 5.2 and the optical sensor 7 in a manner that is not explicitly shown and is configured for controlling them.

Preferably, a first distance between the first lighting device 5.1 and the optical sensor 7 is smaller than a second distance between the second lighting device 5.2 and the optical sensor 7. Especially preferably, the first distance is less than 50 cm, preferably less than 20 cm, preferably less than 10 cm. Especially preferably, the second distance is also more than 50 cm, preferably more than 100 cm, preferably more than 150 cm.

The first lighting device 5.1 and the second lighting device 5.2 preferably have at least one surface emitter, in particular a so-called VCSE laser.

FIG. 1 in particular shows a first lighting frustum 11.1 of the first lighting device 5.1, a second lighting frustum 11.2 of the second lighting device 5.2 and an observation region 13 of the optical sensor 7. A visible distance range 15 is also shown by cross-hatching, which occurs as a part of the first lighting frustum 11.1 of the first lighting device 5.1, of the second lighting frustum 11.2 of the second lighting device 5.2 and of the observation region 13 of the optical sensor 7.

Preferably, the calibrating device 3 has a communication device 16, which is configured in order to transmit information regarding a calibration of the first lighting device 5.1, the second lighting device 5.2 and the optical sensor 7 from the control device 9 to a driver of the motor vehicle 1 and/or to a computer centre and/or to a workshop. Alternatively or additionally, the calibrating device 3 has a first cleaning device for the first lighting device 5.1. Alternatively or additionally, the calibrating device 3 has a second cleaning device for the second lighting device 5.2.

The control device 9 is in particular configured for carrying out an embodiment, described in more detail in the following, of a method for calibrating the first lighting device 5.1, the second lighting device 5.2 and the optical sensor 7.

A controlling of the first lighting device 5.1, the second lighting device 5.2 and the optical sensor 7 are temporally coordinated with each other, and the coordinated controlling is associated with the visible distance range 15. By means of the coordinated controlling, a first recorded image is captured with the optical sensor 7 during an illumination by means of the first lighting device 5.1. Furthermore, by means of the coordinated controlling, a second recorded image is captured with the optical sensor 7 during an illumination by means of the second lighting device 5.2. From the difference between the first recorded image and the second recorded image, a differential recorded image 17 is formed. The coordinated controlling is evaluated and/or changed on the basis of the differential recorded image 17. Alternatively or additionally, the first lighting device 5.1, in particular the controlling and/or the luminous intensity of the first lighting device 5.1, is evaluated and/or changed on the basis of the differential recorded image 17. Alternatively or additionally, the second lighting device 5.2, in particular the controlling and/or the luminous intensity of the second lighting device 5.2 is evaluated and/or changed on the basis of the differential recorded image 17. Alternatively or additionally, the first lighting device 5.1 and/or the second lighting device 5.2 is/are cleaned on the basis of the evaluation of the differential recorded image 17.

Preferably, the coordinated controlling of the first lighting device 5.1, the second lighting device 5.2 and the optical sensor 7 is evaluated and/or changed in such a way that a first image-side visible distance range in the first recorded image and a second image-side visible distance range in the second recorded image represent an identical region of the object-side observation region 13, in particular of the visible distance range 15. Alternatively or additionally, a first brightness distribution 21.1 in the first recorded image is compared with a second brightness distribution 21.2 of the second recorded image.

Preferably, an image registration is carried out in the first recorded image and the second recorded image before the formation of the differential recorded image 17.

Preferably, the first recorded image and the second recorded image are captured in a time interval of less than 0.01 seconds, preferably less than 0.001 seconds.

Preferably, a plurality of first recorded images and a plurality of second recorded images are alternately captured. Furthermore, an average first recorded image is determined from the plurality of first recorded images and an average second recorded image is determined from the plurality of second recorded images. The differential recorded image 17 is then formed as the difference between the average first recorded image and the average second recorded image.

Preferably, a third recorded image is captured with the optical sensor without illumination by means of the first lighting device 5.1 or the second lighting device 5.2. Furthermore, the differential recorded image 17 is formed from the first recorded image, the second recorded image and the third recorded image. The third recorded image in particular corresponds to a daylight recorded image.

Preferably, at least one recorded image, from which the differential recorded image 17 is formed, is calibrated with a lighting factor. The lighting factor is determined based on a difference, in particular a previously known difference, of the luminous intensity between the first lighting device 5.1 and the second lighting device 5.2.

Preferably, at least one recorded image, from which the differential recorded image 17 is formed, is calibrated with a rim light fall-off correction. The rim light fall-off correction is determined based on the rim light fall-off of the optical sensor 7. Advantageously, a darkening of the recorded image or decrease of the brightness around the image rim is thus corrected.

Preferably, the first lighting device 5.1, the second lighting device 5.2 and the optical sensor 7 are included in the coordinated controlling with the intrinsic speed of the motor vehicle 1.

FIG. 2 a) shows a schematic representation of a first differential recorded image 17, as the difference between the first recorded image and the second recorded image. The differential recorded image 17 can be divided into five sections 19. In a first section 19.1, a third section 19.3 and a fifth section 19.5, nothing is shown. It can therefore be concluded that the first recorded image and the second recorded image are identical in the first section 19.1, the third section 19.3 and the fifth section 19.5 and thus no image information remains in the case of a differential formation of both recorded images. In a second section 19.2 and in a fourth section 19.4, objects can be recognized in the first recorded image and/or the second recorded image. It can therefore be concluded that the first recorded image and the second recorded image are not identical in the second section 19.2 and in the fourth section 19.4. Such a sequence of sections, which comprise the complete horizontal dimension of the differential recorded image 17, suggests that the first image-side visible distance range or the second image-side visible distance range do not correspond to the associated visible distance range 15. Thus, in the case of a differential formation of both recorded images, not all image information is erased.

The first section 19.1 and the fifth section 19.5 are dark both in the differential recorded image 17 and also in the first recorded image and the second recorded image. In these sections 19.1, 19.5, there is no exposure due to the controlling of the lighting devices 5 and of the optical sensor 7.

FIG. 2 b) shows a schematic representation of a first example of a first brightness distribution 21.1 and a second brightness distribution 21.2. A brightness distribution 21.1, 21.2 assigns a luminous intensity to every image line. Preferably, the luminous intensity of an image line comes from the sum of the luminous intensities of all pixels of the respective image line. Alternatively, the luminous intensity of an image line comes from the average of the luminous intensities of all pixels of the respective image line.

The first brightness distribution 21.1 is the brightness distribution of the first recorded image, which is used for the formation of the differential recorded image 17 from FIG. 2 a). The second brightness distribution 21.2 is the brightness distribution of the second recorded image, which is used for the formation of the differential recorded image 17 from FIG. 2 b).

The horizontal axis of the vertical brightness distributions 21.1, 21.2 can also be divided into the five vertical sections 19. Here it can also be clearly seen that the first brightness distribution 21.1 and the second brightness distribution 21.2 match in the first section 19.1, the third section 19.3 and the fifth section 19.5. In the second section 19.2 and in the fourth section 19.4, the first brightness distribution 21.1 and the second brightness distribution 21.2 differ significantly from each other. The comparison of the first brightness distribution 21.1 and the second brightness distribution 21.2 thus also shows that the first image-side visible distance range or the second image-side visible distance range does not correspond to the associated visible distance range 15.

FIG. 3 a) shows a schematic representation of a second differential recorded image 17, as the difference between a first recorded image and a second recorded image. The recorded image 17 can be divided into three sections 19. Nothing is shown in the first section 19.1 and in the third section 19.3. It can therefore be concluded that the first recorded image and the second recorded image are identical in the first section 19.1 and the third section 19.3. In the second section 19.2, objects can be recognized in the first recorded image and/or the second recorded image. It can therefore be concluded that the first recorded image and the second recorded image are not identical in the second section 19.2. This sequence of three sections, which comprise the complete horizontal dimension of the differential recorded image 17, suggests that the first luminous intensity of the first recorded image and the second luminous intensity of the second recorded image are different.

The first section 19.1 and the third section 19.3 are dark both in the differential recorded image 17 and also in the first recorded image and the second recorded image. In these sections 19.1, 19.3, there is, similarly to FIG. 2 a), no exposure due to the controlling of the lighting devices 5 and of the optical sensor 7.

A possible cause for the difference between the first luminous intensity and the second luminous intensity is a different controlling of the first lighting device 5.1 and the second lighting device 5.2. A further possible cause is a dirtying of the first lighting device 5.1 and/or of the second lighting device 5.2. A further possible cause is a defect, in particular a failure of a part of the light source, in particular of a part of the surface emitter of the first lighting device 5.1 and/or of the second lighting device 5.2.

FIG. 3 b) shows a schematic representation of a second example of a first brightness distribution 21.1 and a second brightness distribution 21.2. The first brightness distribution 21.1 is the brightness distribution of the first recorded image, which is used for the formation of the differential recorded image 17 from FIG. 3 a). The second brightness distribution 21.2 is the brightness distribution of the second recorded image, which is used for the formation of the differential recorded image 17 from FIG. 3 b).

The horizontal axis of the vertical brightness distributions 21.1, 21.2 can also be divided into the three vertical sections 19. Here it can also be clearly seen that the first brightness distribution 21.1 and the second brightness distribution 21.2 match in the first section 19.1 and the third section 19.3. In the second section 19.2, the first brightness distribution 21.1 and the second brightness distribution 21.2 have a similar path, but are displaced from each other in height or intensity. The comparison of the first brightness distribution 21.1 and the second brightness distribution 21.2 thus shows that the first luminous intensity of the first recorded image and the second luminous intensity of the second recorded image differ significantly from each other.

FIG. 4 shows a schematic representation of a third example of a first brightness distribution 19.1 and a second brightness distribution 19.2. The horizontal axis of the brightness distributions 21.1, 21.2 can also be divided into the five sections 19. In the first section 19.1 and in the fifth section 19.5, the first brightness distribution 21.1 and the second brightness distribution 21.2 are identical. In the second section 19.2 and in the fourth section 19.4, exactly one brightness distribution 21.1, 21.2 has a luminous intensity different from zero. It is thus clear that the first image-side visible distance range and the second image-side visible distance range differ and at least one of the image-side visible distance ranges does not correspond to the associated visible distance range 15. In the third section 19.3, the first brightness distribution 21.1 and the second brightness distribution 21.2 have a similar path, but are displaced from each other in height or intensity, as previously in FIG. 3 b). It is thus furthermore clear that the first luminous intensity first recorded image and the second luminous intensity of the second recorded image differ significantly from each other.

1.-10. (canceled)

11. A method for calibrating a first lighting device (5.1), a second lighting device (5.2), and an optical sensor (7), comprising the steps of:
controlling the first lighting device (5.1), the second lighting device (5.2), and the optical sensor (7) in a temporally coordinated manner;
associating the controlling with a visible distance range;
capturing a first recorded image with the optical sensor (7) by the controlling during an illumination by the first lighting device (5.1);
capturing a second recorded image with the optical sensor (7) by the controlling during an illumination by the second lighting device (5.2);
forming a differential recorded image (17) as a difference between the first recorded image and the second recorded image; and
evaluating and/or changing the coordinated controlling and/or the first lighting device (5.1) and/or the second lighting device (5.2) on a basis of the differential recorded image (17).

12. The method according to claim 11, wherein:
a plurality of first recorded images and a plurality of second recorded images are alternately captured;
an average first recorded image is determined from the plurality of first recorded images;
an average second recorded image is determined from the plurality of second recorded images; and
the differential recorded image (17) is formed as a difference between the average first recorded image and the average second recorded image.

13. The method according to claim 11, further comprising the step of capturing a third recorded image with the optical sensor (7) during a time with no illumination by the first lighting device (5.1) or the second lighting device (5.2), wherein the differential recorded image (17) is formed from the first recorded image, the second recorded image, and the third recorded image.

14. The method according to claim 11, further comprising the step of calibrating at least one recorded image, from which the differential recorded image (17) is formed, with a lighting factor, wherein the lighting factor is determined based on a difference of a luminous intensity between the first lighting device (5.1) and the second lighting device (5.2).

15. The method according to claim 11, further comprising the step of calibrating at least one recorded image, from which the differential recorded image (17) is formed, with a rim light fall-off correction, wherein the rim light fall-off correction is determined based on a rim light fall-off of the optical sensor (7).

16. The method according to claim 11, wherein the first lighting device (5.1), the second lighting device (5.2), and the optical sensor (7) are included in the controlling with an intrinsic speed of a motor vehicle (1) which has the first lighting device (5.1), the second lighting device (5.2), and the optical sensor (7).

17. A control device (9) configured to perform the method according to claim 11.

18. A calibrating device (3), comprising:
a first lighting device (5.1);
a second lighting device (5.2);
an optical sensor (7); and
a control device (9) configured to perform the method according to claim 11.

19. The calibrating device (3) according to claim 18, further comprising at least one of a communication device (16), a first cleaning device for the first lighting device (5.1), and a second cleaning device for the second lighting device (5.2).
